(19) United States
(12) Patent Application Publication
(10) Pub. No.: US 2005/0206024 A1
(43) Pub. Date: Sep. 22, 2005

(54) Apparatus and method for producing decorated plastic product

(76) Inventors: David J. Jochem, Evansville, IN (US); Jeffrey A. Mann, Evansville, IN (US); Milan C. Maravich, Evansville, IN (US); Alan Welch, Versailles, IN (US)

Correspondence Address: BARNES & THORNBURG, 11 SOUTH MERIDIAN, INDIANAPOLIS, IN, 46204, US

(21) Appl. No.: 10/804,906

(22) Filed: Mar. 19, 2004

(51) Int. Cl. B29C 47/00

(52) U.S. Cl. 264/40.1; 264/132; 264/210.1; 264/319

(57) ABSTRACT

Apparatus and methods for producing a decorated plastic product are disclosed. A strip of plastics material is extruded from a strip extruder and moved along a production line in sequence from the strip extruder past a decoration media dispenser to a thermoformer. At the decoration media dispenser, decoration media is dispensed from the decoration media dispenser onto a portion of the strip. The thermoformer is used to heat and form the decorated strip portion into the plastic product.

### BACKGROUND

The present disclosure relates to apparatus and methods for producing decorated plastic products. More particularly, the present disclosure relates to configuration and operation of a production line to produce products made of a plastics material.

It is often desirable for products made of a plastics material to be decorated. Such decoration may be desirable for a variety of reasons. For example, decoration may be applied to plastic products for reasons of aesthetics, advertising, or communication of other information, to name just a few.

### SUMMARY

According to the present disclosure, a method of operating a production line to produce a decorated plastic product is disclosed. A strip of plastics material is extruded from a strip extruder and moved along the production line in sequence from the strip extruder past a decoration media dispenser to a thermoformer. At the decoration media dispenser, decoration media is dispensed from the decoration media dispenser onto at least a portion of the strip. The thermoformer is used to heat and form the decorated strip portion into the plastic product.

In illustrative embodiments, the decoration media dispenser may be positioned at different locations in the production line between the strip extruder and the thermoformer. In one example, the decoration media dispenser is positioned downstream from a strip mover used to move the strip along the production line. In another example, the decoration media dispenser is positioned upstream from the strip mover.

Two types of decoration media dispensers are disclosed: a sprayer dispenser and a roller dispenser. The sprayer dispenser is used to spray decoration media onto the strip. Media and air suppliers under the control of a controller supply decoration media and air to the sprayers. The roller dispenser is used to roll decoration media onto the strip. A decoration media supplier under the control of a controller supplies decoration media to the roller dispenser.

Additional features of the disclosure will become apparent to those skilled in the art upon consideration of the following detailed description exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a method of operating a production line to produce a decorated plastic product by extruding a strip of plastics material from a strip extruder, dispensing decoration media from a decoration media dispenser onto a portion of the strip, and thermoforming the decorated strip portion into the decorated plastic product by operation of the thermoformer;

FIG. 2 is a diagrammatic view of a method in accordance with the present disclosure showing the decoration media dispenser positioned downstream from a strip mover;

FIG. 3 is a side elevation view showing one embodiment of the decoration media dispenser configured as a sprayer dispenser coupled to a frame downstream from the strip mover;

FIG. 4 is an elevation view as viewed in a direction suggested by lines 4-4 of FIG. 3 showing the sprayer dispenser including four sprayers aligned along the width of the extruded strip;

FIG. 5 is a side elevation view of an embodiment of the disclosure showing the sprayer dispenser coupled to media and air suppliers under the control of a controller to provide pressurized decoration media and pressurized air to the sprayer dispenser;

FIG. 6 is a perspective view of one of the sprayers;

FIG. 7 is a side elevation view of an embodiment of the disclosure showing the decoration media dispenser configured as roller dispenser coupled to the frame downstream from the strip mover;

FIG. 8 is an elevation view as viewed in a direction suggested by lines 8-8 of FIG. 7 showing application of decoration media to the strip by a lower applicator roller that receives decoration media from an upper transfer roller;

FIG. 9 is a perspective view of the applicator roller;

FIG. 10 is a side elevation view of the applicator roller;

FIG. 11 is a diagrammatic view of a method in accordance with the present disclosure showing the decoration media dispenser positioned upstream from the strip mover;

FIG. 12 is a side elevation view of an embodiment of the disclosure showing the sprayer dispenser coupled to the frame upstream from the strip mover;

FIG. 13 is a sectional view taken along lines 13-13 of FIG. 12;

FIG. 14 is a side elevation view showing the roller dispenser coupled to the frame upstream from the strip mover; and

FIG. 15 is a sectional view taken along lines 15-15 of FIG. 14.

### DETAILED DESCRIPTION

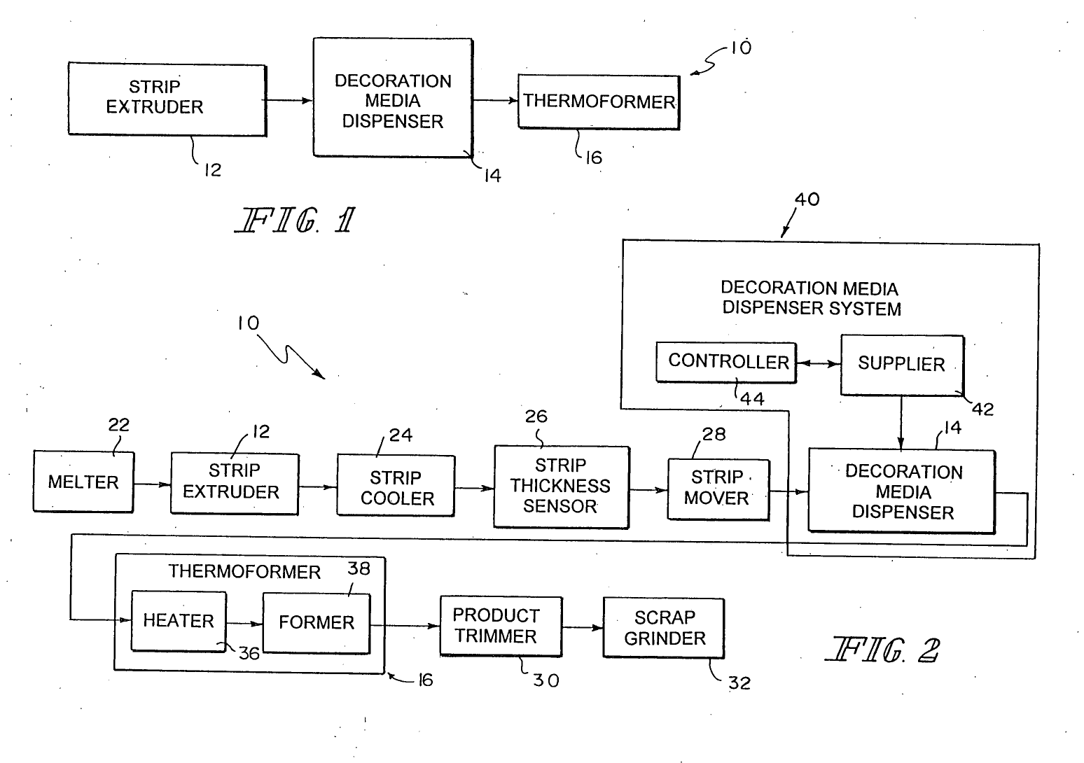

A method of operating a production line 10 for producing a decorated plastic product is shown, for example, in FIG. 1. Production line 10 includes a strip extruder 12, a decoration media dispenser 14, and a thermoformer 16. Strip extruder 12 extrudes a strip 18 (e.g., a sheet) of plastics material shown, for example, in FIGS. 3, 4, 7, 8, and 12-15. Strip 18 is moved along production line 10 in sequence from strip extruder 12 past decoration media dispenser 14 to thermoformer 16. At dispenser 14, decoration media is dispensed from dispenser 14 onto a portion 20 of strip 18, as shown, for example, in FIGS. 3, 4, 7, 8, and 12-15. After decoration media is dispensed onto strip portion 20, thermoformer 16 is used to heat and form strip portion 20 into the decorated plastic product.

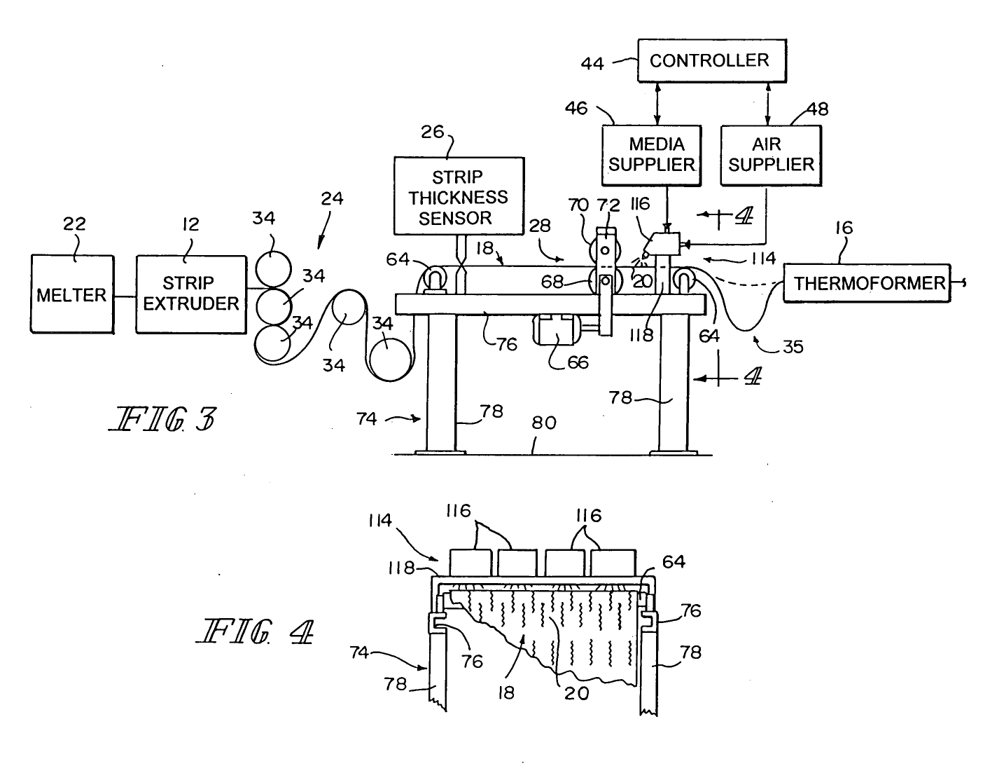

Additional components of production line 10 are shown diagrammatically, for example, in FIG. 2. The additional components include a melter 22, a strip cooler 24, a strip thickness sensor 26, a strip mover 28, a product trimmer 30, and a scrap grinder 32. Melter 22 melts plastic material before it is supplied to strip extruder 12.

Strip cooler 24, strip thickness sensor 26, and strip mover 28 are positioned in production line 10 between extruder 12 and thermoformer 16 along with decoration media dispenser 14. Strip portion 20 moves along production line 10 in sequence from extruder 12 past cooler 24, sensor 26, mover 28, and dispenser 14 to thermoformer 16, as shown, for example, in FIG. 3. Strip cooler 24 cools strip portion 20 just after it is extruded from extruder 12 and includes, for example, five cooler rollers 34. Strip thickness sensor 26 senses the thickness of strip portion 20 for feedback control of extruder 12.

Strip mover 28 is used to move strip portion 20 along production line 10 from extruder 12 toward thermoformer 16. Strip mover 28 operates in a continuous manner to accommodate the constant-feed operation of extruder 12.

Dispenser 14 dispenses decoration media onto strip portion 20 after strip portion 28 passes strip mover 28. A variety of dispensers may be used to dispense decoration media onto strip portion 20. Two such dispensers are discussed in more detail herein. The decoration media is material (e.g., ink or paint) which can be dispensed onto strip portion 20 and which will remain, at least in part, on strip portion 20 for use on the plastic product.

After strip portion 20 passes dispenser 14, it enters a slack-forming region 35 where slack is allowed to form in strip 18, as shown, for example, in FIG. 3. Such slack forms periodically in strip 18 due to the constant feed of extruder 12 and incremental movement of strip 18 by thermoformer 16.

Thermoformer 16 includes a heater 36 and a former 38, as shown diagrammatically, for example, in FIG. 2. Heater 36 is used to heat decorated strip portion 20 and former 38 forms heated and decorated strip portion 20 into a desired shape to produce one or more decorated plastic products.

Product trimmer 30 is used to trim the one or more decorated plastic product from strip portion 20. The portion of strip portion 20 not formed into a plastic product is passed through scrap grinder 22 for reuse. It is within the scope of this disclosure for product trimmer 30 to be located next to former 38 to trim the decorated plastic products in conjunction with operation of former 38.

Dispenser 14 is included in a decoration media dispenser system 40, as shown diagrammatically, for example, in FIG. 2. A supplier 42 under the control of a controller 44 supplies pressurized decoration media to dispenser 14. Depending on the configuration of dispenser 14, supplier 42 may also provide pressurized air to dispenser 14, as discussed in more detail herein.

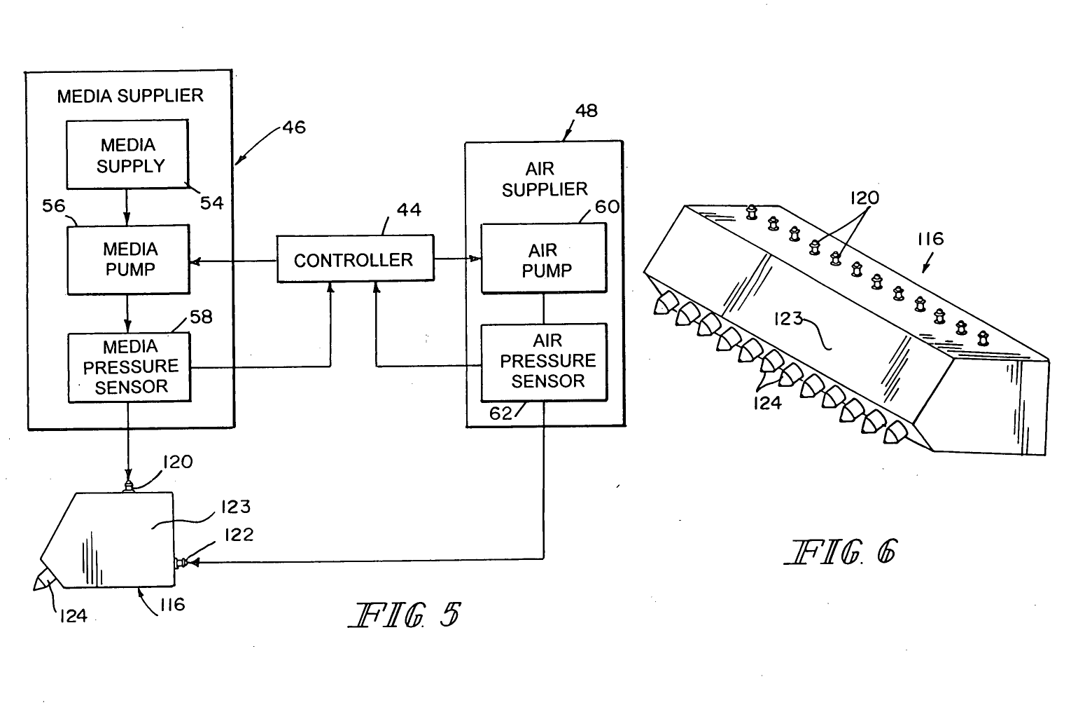

A sprayer dispenser 114 shown, for example, in FIGS. 3 and 4, is one example of dispenser 14. Sprayer dispenser 114 is used to spray decoration media onto strip portion 20. Illustratively, sprayer dispenser 114 includes four sprayers 116 coupled to a sprayer mount 118 and aligned along the width of strip portion 20, as shown, for example, in FIG. 4.

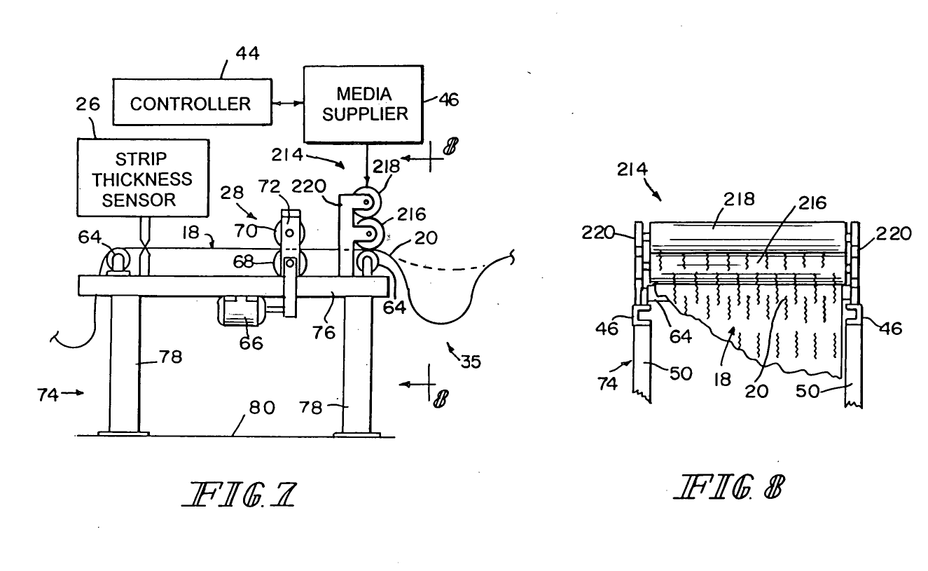

When used with sprayer dispenser 114, supplier 42 includes a media supplier 46 and an air supplier 48, as shown, for example, in FIGS. 3 and 5. Media supplier 46 supplies pressurized decoration media to a plurality of media inlets 120 included in each sprayer 116 and shown, for example, in FIGS. 5 and 6. Air supplier 48 includes pressurized air to a plurality of air inlets 122 included in each sprayer 116 and shown, for example, in FIG. 5. The pressurized decoration media and air are mixed in a housing 123 included in each sprayer 116 and the mixture is discharged from a plurality of outlets 124 includes in each sprayer 116, as shown, for example, in FIGS. 5 and 6.

Media supplier 46 includes a media supply 54, a media pump 56, and a media pressure sensor 58, as shown, for example, in FIG. 5. Media pump 56 pumps decoration media from media supply 54 past sensor 58 to media inlets 120. Sensor 58 senses the pressure of decoration media and provides media pressure information representative of the media pressure to controller 44.

Air supplier 48 includes an air pump 60 and an air pressure sensor 62, as shown, for example, in FIG. 5. Air pump 60 pumps air past air pressure sensor 62 to air inlets 122. Sensor 62 senses the air pressure and provides air pressure information representative of the air pressure to controller 44.

Controller 44 uses the media pressure information from media pressure sensor 58 and the air pressure information from air pressure sensors 62 to control operation of media pump 56 and air pump 60. In this way, controller 44 is able to control operation of media supplier 46 and air supplier 48 so that a desired amount of decoration media will be sprayed onto strip portion 20.

Sprayer mount 118 and other components are coupled to a frame 74, as shown, for example, in FIGS. 3 and 4. Frame 74 includes a pair of horizontal beams 76 and four vertical supports 78 to support beams 46 above a floor 80. Sprayer mount 118, a pair of guide rollers 64, strip thickness sensor 26, and strip mover 28 are coupled to beams 46.

Strip mover 28 includes a motor 66, a drive roller 68, and an idler roller 70, as shown, for example, in FIG. 3. Motor 66 is used to rotate drive roller 68 to move strip portion 20 between drive roller 68 and idler roller 70. Motor 66 is coupled one of beams 46. Drive and idler rollers 68, 70 are coupled to beams 46 by a mover mount 72.

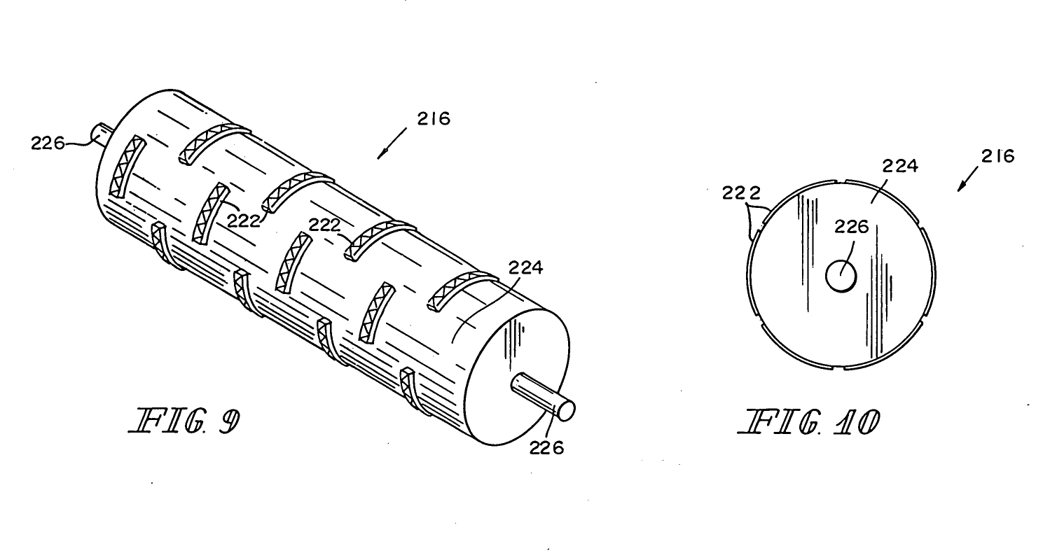

A roller dispenser 214 shown, for example, in FIGS. 7 and 8, is one example of dispenser 14. Roller dispenser 214 is used to roll decoration media onto strip portion 20.

Illustratively, roller dispenser 214 includes an applicator roller 216 shown, for example, in FIGS. 7-10, and a transfer roller 218 shown, for example, in FIGS. 7 and 8. Applicator roller 216 rolls decoration media onto strip portion 20. Transfer roller 218 rolls decoration media supplied thereto onto applicator roller 216. Applicator roller 216 and transfer roller 218 are coupled to horizontal beams 46 by a roller dispenser mount 220.

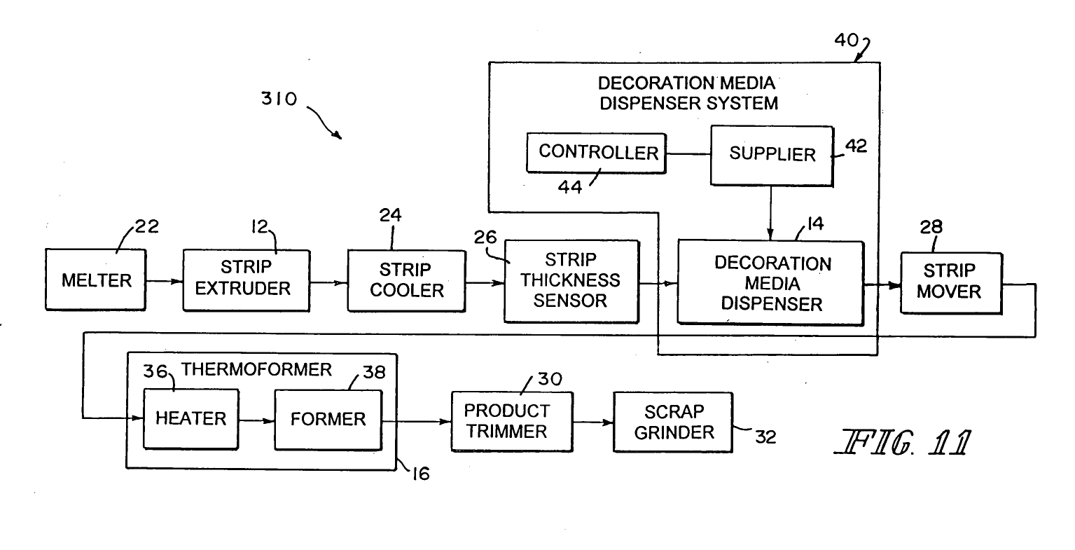

Applicator roller 216 includes a plurality of media applicator lugs 222 for application of decoration media onto strip portion 20, as shown, for example, in FIGS. 9 and 10. Lugs 222 are coupled to a cylindrical body 224. Shafts 226 are coupled to the ends of body 224 for rotation body 224 and lugs 222 therewith.

When used with roller dispenser 214, supplier 42 is configured as media supplier 46, as shown, for example, in FIG. 7. Media supplier 46 supplies pressurized decoration media to transfer applicator 218. Controller uses the media pressure information from media pressure sensor 58 to control operation of media pump 56 so that a desired amount of decoration media will be rolled onto strip portion 20.

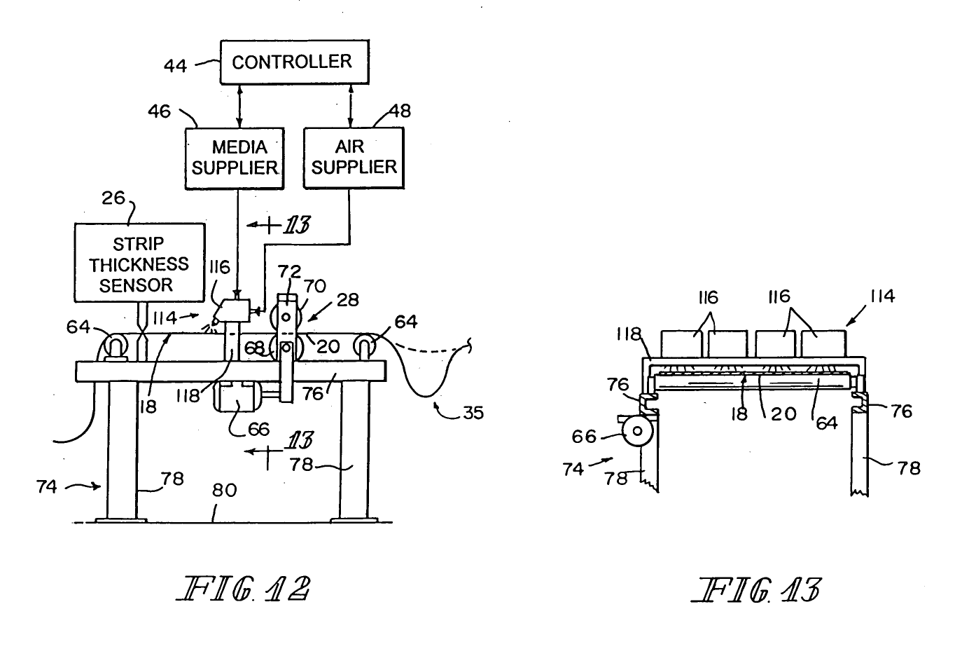

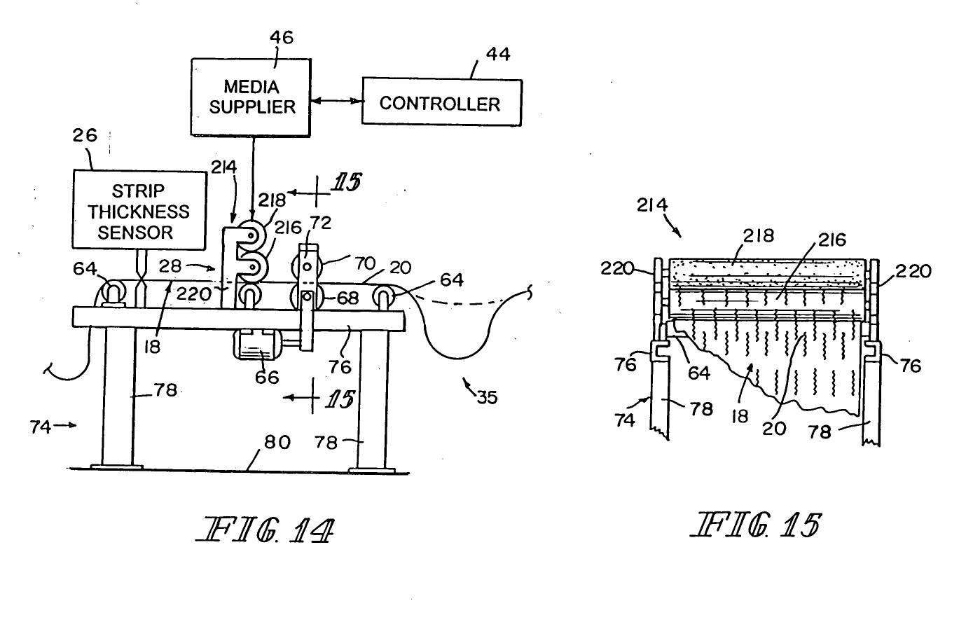

A production line 310 is similar in structure and function to production line 10 except that decoration media dispenser 14 is positioned upstream from strip mover 28 so that decoration media is dispensed from dispenser 14 onto strip portion 20 before strip portion 20 passes strip mover 28, as shown diagrammatically, for example, in FIG. 11. Such an arrangement is useful when dispenser 14 is configured as sprayer dispenser 114, as shown, for example, in FIGS. 12 and 13, and when dispenser 14 is configured as roller dispenser 214, as shown, for example, in FIGS. 14 and 15.

1. A method of operating a production line to produce a decorated plastic product, the method comprising
extruding a strip of plastics material from a strip extruder,
moving the strip along the production line in sequence from the strip extruder past a decoration media dispenser to a thermoformer,
dispensing decoration media from the decoration media dispenser onto a portion of the strip, and
thermoforming the strip portion into the decorated plastic product by operation of the thermoformer after the dispensing act.

2. The method of claim 1, wherein the dispensing act includes spraying decoration media from a sprayer onto the strip portion.

3. The method of claim 2, wherein the dispensing act includes supplying pressurized decoration media from a media supplier to the sprayer and supplying pressurized air from an air supplier to the sprayer.

4. The method of claim 3, wherein the dispensing act includes controlling operation of the media supplier and the air supplier by operation of a controller.

5. The method of claim 4, wherein the media supplying act includes pressurizing decoration media by operation of a media pump, sensing the pressure of the pressurized decoration media, and providing media pressure information representative of the pressure of the pressurized decoration media to the controller and the controlling act includes controlling operation of the media pump based on the media pressure information.

6. The method of claim 4, wherein the air supplying act includes pressurizing air by operation of an air pump, sensing the pressure of the pressurized air, and providing air pressure information representative of the pressure of the pressurized air to the controller and the controlling act includes controlling operation of the air pump based on the air pressure information.

7. The method of claim 1, wherein the dispensing act includes rolling decoration media onto the strip portion.

8. The method of claim 7, wherein the rolling act includes rolling a transfer roller against an applicator roller to provide decoration media on the applicator roller and rolling the applicator roller against the strip portion to apply decoration media on the strip portion.

9. The method of claim 8, wherein the dispensing act includes supplying pressurized decoration media from a media supplier to the transfer roller and controlling operation of the media supplier by operation of a controller.

10. The method of claim 9, wherein the media supplying act includes pressurizing the decoration media by operation of a media pump, sensing the pressure of the pressurized decoration media, and providing media pressure information representative of the pressure of the pressurized decoration media to the controller and the controlling act includes controlling operation of the media pump based on the media pressure information.

11. A method of operating a production line to produce a decorated plastic product, the method comprising
extruding a strip of plastics material from a strip extruder,
moving the strip along the production line in sequence from the strip extruder past a strip mover and a decoration media dispenser toward a thermoformer by operation of the strip mover,
dispensing decoration media from the decoration media dispenser onto a portion of the strip after the strip portion passes the strip mover, and
thermoforming the strip portion into the decorated plastic product by operation of the thermoformer after the dispensing act.

12. The method of claim 11, wherein the strip mover and the decoration media dispenser are coupled to a frame.

13. The method of claim 11, wherein the dispensing act includes spraying the decoration media onto the strip portion from a plurality of sprayers aligned along the width of the strip portion and the plurality of sprayers and the strip mover are coupled to a frame.

14. The method of claim 11, wherein the dispensing act includes rolling a transfer roller on an applicator roller to provide decoration media on the applicator roller and rolling the applicator roller on the strip portion to apply decoration media on the strip portion and the transfer roller, the applicator roller, and the strip mover are coupled to a frame.

15. A method of operating a production line to produce a decorated plastic product, the method comprising
extruding a strip of plastics material from a strip extruder,
moving the strip along the production line in sequence from the strip extruder past a decoration media dispenser and a strip mover toward a thermoformer by operation of the strip mover,
dispensing decoration media from the decoration media dispenser onto a portion of the strip before the strip portion passes the strip mover, and
thermoforming the strip portion into the decorated plastic product by operation of the thermoformer after the dispensing act and after the strip portion passes the strip mover.

16. The method of claim 15, wherein the strip mover and the decoration media dispenser are coupled to a frame.

17. The method of claim 15, wherein the moving act includes driving a drive roller against the strip portion by operation of a motor, the dispensing act includes spraying the decoration media from a sprayer onto the strip portion, and the roller, the motor, and the sprayer are coupled to a frame.

18. The method of claim 15, wherein the moving act includes driving a drive roller against the strip portion by operation of a motor, the dispensing act includes rolling a transfer roller against an applicator roller to provide decoration media on the applicator roller and rolling the applicator roller against the strip portion to apply decoration media on the strip portion, and the drive roller, the motor, the transfer roller, and the applicator roller are coupled to a frame.

19. A method of operating a production line to produce a decorated plastic product, the method comprising
extruding a strip of plastics material,
dispensing decoration media onto a portion of the strip, and
thermoforming the strip portion into the decorated plastic product after the dispensing act.

20. The method of claim 19, wherein the dispensing act includes spraying decoration media onto the strip portion.

21. The method of claim 20, wherein the spraying act includes operating a sprayer and the dispensing act includes supplying pressurized decoration media from a media supplier to the sprayer and supplying pressurized air from an air supplier to the sprayer and controlling operation of the media supplier and the air supplier.

22. The method of claim 21, wherein the media supplying act includes pressurizing decoration media by operation of a media pump, sensing the pressure of the pressurized decoration media, and providing media pressure information representative of the pressure of the pressurized decoration media to a controller, the air supplying act includes pressurizing air by operation of an air pump, sensing the pressure of the pressurized air, and providing air pressure information representative of the pressure of the pressurized air to the controller, and the controlling act includes controlling operation of the media pump based on the media pressure information and controlling operation of the air pump based on the air pressure information.

23. The method of claim 19, wherein the dispensing act includes rolling decoration media onto the strip portion.

24. The method of claim 19, wherein the dispensing act includes dispensing decoration media from a decoration media dispenser onto the strip portion, supplying pressurized decoration media to the decoration media dispenser by operation of a media supplier, and controlling operation of the media supplier by operation of a controller.

25. The method of claim 19, further comprising cooling the strip portion by operation of a strip cooler before the dispensing act.

26. The method of claim 19, further comprising sensing the thickness of the strip portion before the dispensing act.

27. The method of claim 19, further comprising moving the strip portion through slack formed in the strip after the dispensing act.
